(19) United States
(12) Patent Application Publication
(10) Pub. No.: US 2019/0036217 A1
(43) Pub. Date: Jan. 31, 2019

(54) Selectable Filtering with Switching

(71) Applicant: QUALCOMM Incorporated, San Diego, CA (US)

(72) Inventors: Calogero Davide Presti, San Diego, CA (US); Ryan Scott Castro Spring, San Diego, CA (US); Yu Zhao, San Diego, CA (US)

(21) Appl. No.: 15/710,720

(22) Filed: Sep. 20, 2017

Related U.S. Application Data
(60) Provisional application No. 62/539,474, filed on Jul. 31, 2017.

(51) Int. Cl. H01Q 5/328; H04B 1/48; H04B 1/00

(52) U.S. Cl. CPC H01Q 5/328; H04B 1/0057; H04B 1/006; H04B 1/48

(57) ABSTRACT

An example apparatus is disclosed for selectable filtering with switching. The apparatus includes an antenna switch module mounted to a surface of a substrate. The antenna switch module includes an antenna node, multiple switchable nodes, and multiple switches configured to connect or disconnect the multiple switchable nodes to or from the antenna node. The antenna switch module also includes a capacitor coupled in series with a first switch of the multiple switches between the antenna node and a first switchable node of the multiple switchable nodes. The capacitor is configured to provide a capacitance for a selectable filter. The apparatus also includes an inductor that is supported by the substrate and coupled between the first switchable node and a ground. The inductor is configured to provide an inductance for the selectable filter.

### CROSS-REFERENCE TO RELATED APPLICATION(S)

This application claims the benefit of U.S. Provisional Application No. 62/539,474 filed 31 Jul. 2017, the disclosure of which is hereby incorporated by reference in its entirety herein.

### TECHNICAL FIELD

This disclosure relates generally to wireless devices and, more specifically, to a selectable filter that can be enabled, disabled, or tuned using switching.

### BACKGROUND

To improve data rates and network performance, current techniques enable a wireless device to simultaneously transmit and receive on separate frequency bands. The wireless device can include multiple transceivers to simultaneously transmit and receive communication signals of different frequencies using separate antennas. The transceivers typically include band-pass filters that can be tuned to different frequency bands. Unfortunately, a spurious frequency generated by operations associated with one of the frequency bands can impact operation at another frequency band. For example, a harmonic frequency of a low-frequency band uplink signal being emanated by one transceiver can decrease the sensitivity of another transceiver that is receiving a mid-frequency band downlink signal. As additional frequency bands are supported by a given wireless device, it can become challenging to provide sufficient cross-isolation for the additional frequency bands.

### SUMMARY

An apparatus is disclosed that implements selectable filtering with switching. The switching enables the apparatus to provide the selectable filtering when it is beneficial to provide additional attenuation, such as when a harmonic frequency of a transmission frequency band falls within a reception frequency band. The selectable filtering can be disabled to reduce insertion loss when the additional attenuation is not needed. Furthermore, the selectable filtering enables the apparatus to provide the additional attenuation at a variety of suppression frequency bands.

In an example aspect, an apparatus is disclosed. The apparatus includes an antenna switch module mounted to a surface of a substrate. The antenna switch module includes an antenna node that is configured to couple to an antenna, multiple switchable nodes including a first switchable node, and multiple switches configured to connect or disconnect the multiple switchable nodes to or from the antenna node. The multiple switches include a first switch coupled between the antenna node and the first switchable node. The antenna switch module also includes a capacitor coupled in series with the first switch between the antenna node and the first switchable node. The capacitor is configured to provide a capacitance for a selectable filter. The apparatus also includes an inductor that is supported by the substrate and coupled between the first switchable node and a ground. The inductor is configured to provide an inductance for the selectable filter.

In an example aspect, an apparatus is disclosed. The apparatus includes an antenna switch module mounted to a surface of a substrate. The antenna switch module includes an antenna node that is configured to couple to an antenna, multiple switchable nodes including a first switchable node, and multiple switches configured to connect or disconnect the multiple switchable nodes to or from the antenna node. The multiple switches include a first switch coupled between the antenna node and the first switchable node. The antenna switch module also includes a capacitor coupled in series with the first switch between the antenna node and the first switchable node. The apparatus also includes a filter means for filtering signals present at the antenna node using the capacitor and the first switch.

In an example aspect, a method for selectable filtering with switching is disclosed. The method includes receiving at least one communication signal parameter providing information regarding a communication operation associated with a wireless device. The method also includes determining, based on the communication signal parameter, a transmission frequency band for transmitting a communication signal and a reception frequency band for receiving an additional communication signal. Based on the transmission frequency band, the method further includes determining at least one spurious frequency associated with the transmission frequency band. Based on the reception frequency band, the at least one spurious frequency is determined to fall within the reception frequency band. The method also includes enabling, via an antenna switch module and responsive to the at least one spurious frequency falling within the reception frequency band, a selectable filter to attenuate the at least one spurious frequency.

An example apparatus is disclosed that includes a first antenna, a first transceiver, a first antenna switch module, a second antenna, a second transceiver, a second antenna switch module, and an inductor. The first antenna switch module includes a first antenna node that is coupled to the first antenna and a first switchable node that is coupled to the first transceiver. The first antenna switch module also includes a first switch configured to connect or disconnect the first switchable node to or from the first antenna node. The second antenna switch module includes a second antenna node that is coupled to the second antenna, multiple switchable nodes, multiple switches, and a capacitor. The multiple switchable nodes include a second switchable node that is coupled to the second transceiver and a third switchable node. The multiple switches are configured to connect or disconnect the multiple switchable nodes to or from the second antenna node. The multiple switches include a second switch and a third switch. The second switch is coupled between the second antenna node and the second switchable node. The third switch is coupled between the second antenna node and the third switchable node. The capacitor is coupled in series with the third switch between the second antenna node and the third switchable node. The capacitor is configured to provide a least a portion of a capacitance for a selectable filter. The inductor is coupled between the third switchable node and a ground. The inductor is configured to provide an inductance for the selectable filter.

### BRIEF DESCRIPTION OF DRAWINGS

FIG. 1 illustrates an example environment for selectable filtering with switching.

FIG. 2-1 illustrates an example wireless transceiver for selectable filtering with switching.

FIG. 2-2 illustrates an example implementation of the wireless transceiver of FIG. 2-1 for selectable filtering with switching.

FIG. 3 illustrates an example distributive configuration for selectable filtering with switching.

FIG. 4 illustrates an example of an antenna switch module and selectable filter for selectable filtering with switching.

FIG. 5 illustrates another example of an antenna switch module and selectable filter for selectable filtering with switching.

FIG. 6 illustrates an example frequency response graph for an electronically-tunable selectable filter.

FIG. 7 illustrates example switch configuration tables for generating a control signal for selectable filtering with switching.

FIG. 8 is a flow diagram illustrating an example process for controlling an antenna switch module for selectable filtering with switching.

FIG. 9 is a flow diagram illustrating an example process for selectable filtering with switching.

### DETAILED DESCRIPTION

In some environments, a wireless device transmits a communication signal to a base station on an uplink (UL) using an antenna and simultaneously receives another communication signal from the base station on a downlink (DL) using another antenna. For example, the wireless device can use frequency band 12 for the uplink (e.g., frequencies between 699 and 716 megahertz (MHz)) and frequency band 4 for the downlink (e.g., frequencies between 2110 and 2155 MHz). While generating the transmitted communication signal, a spurious signal (e.g., an undesirable signal) can be generated from non-linear components in the wireless transceiver, such as power amplifiers, switches, or filters. The spurious signal can have a spurious frequency that is associated with the transmitting frequency band (e.g., higher, lower, or a scalar multiple of the transmitting frequency). In some cases, the spurious frequency falls within the receiving frequency band. Without sufficient rejection (e.g., attenuation), the spurious signal can cause interference for the downlink.

Each communication frequency band used by the wireless device can correspond to a transceiver that includes a band-pass filter to filter signals for the communication frequency band. In some implementations, the communication frequency band can be associated with a transmission frequency band and a reception frequency band so that the band-pass filter can enable signals within both the transmission frequency band and the reception frequency band to pass to/from the transceiver. In addition to passing signals within the communication frequency band, the band-pass filter provides some amount of attenuation for frequencies that are outside the communication frequency band. The frequency bands that the band-pass filter is configured to attenuate are referred to herein as suppression frequency bands.

Some conventional techniques use acoustic resonators to implement the band-pass filter, such as surface acoustic wave (SAW) resonators or bulk acoustic wave (BAW) resonators. However, because it can be difficult to simulate rejection performance, the acoustic resonators are typically tuned to provide desired cross-isolation for the communication frequency bands after fabrication. Unfortunately, the tuning process is usually lengthy and can require a redesign of some of the acoustic resonators or the acoustic resonator substrate.

Other techniques add an additional filter between the band-pass filter and the antenna. However, the location of this additional filter within a transmit-receive signal chain can decrease performance at other communication frequency bands and during operations that do not require the filter.

In contrast with conventional approaches, example apparatuses are described herein for selectable filtering with switching. An apparatus includes an antenna switch module and a selectable filter. The antenna switch module can enable or disable the selectable filter based on a communication operation of the wireless device. The selectable filter attenuates a suppression frequency band for a transceiver that is connected to the selectable filter via the antenna switch module. Thus, in addition to or instead of tuning the band-pass filter of the transceiver, the selectable filter can be used to achieve the desired attenuation for the suppression frequency band. The selectable filter can also be easier to tune compared to the band-pass filter, even after partial fabrication (e.g., by physically substituting a different inductor for the selectable filter or electronically tuning the selectable filter via the antenna switch module). Through switching, the antenna switch module can increase attenuation for the suppression frequency band by enabling the selectable filter or decrease insertion loss by disabling the selectable filter if the additional attenuation is not desired.

For example, a communication operation includes communicating on an uplink using a first transceiver and communicating on a downlink using a second transceiver. The first transceiver transmits a communication signal within a transmission frequency band while the second transceiver receives another communication signal within a reception frequency band. The selectable filter can be tuned to attenuate the spurious frequency that is generated by the first transceiver (e.g., tuned such that the suppression frequency band the selectable filter attenuates includes the spurious frequency). Responsive to the spurious frequency falling within the reception frequency band, the antenna switch module enables the selectable filter on behalf of the second transceiver and because of the first transceiver. Furthermore, instead of the first transceiver communicating on the uplink, a third transceiver may transmit on the uplink using another transmission frequency band. The antenna switch module can enable or disable the selectable filter on behalf of the second transceiver based on whether a spurious frequency that is likely to be generated by the third transceiver falls within the reception frequency band. Thus, by using the antenna switch module to enable or disable the selectable filter, the selectable filter can provide attenuation for more than one transceiver and be enabled based on operations associated with other transceivers.

As another example of a scenario for using a switchable filter with an antenna switch module, a communication operation can cause the first transceiver to switch from communicating on the uplink to communicating on the downlink. In response, the antenna switch module can disconnect the selectable filter to decrease an insertion loss for the downlink.

In some implementations, the antenna switch module can also electronically tune the selectable filter for different suppression frequency bands using, for example, one or more capacitors of the antenna switch module. In this way, the selectable filter can be used to provide attenuation for multiple spurious frequencies that are associated with a same transmission frequency band or with multiple different transmission frequency bands.

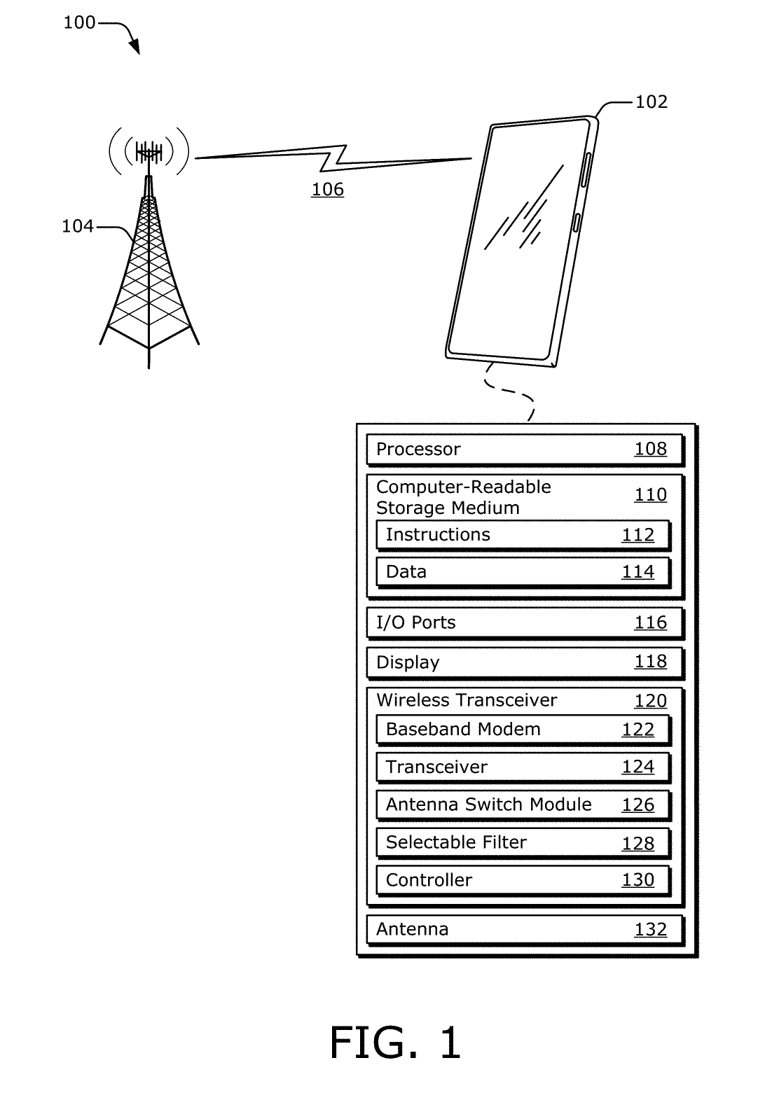

FIG. 1 illustrates an example environment 100, which includes a computing device 102 that communicates with a base station 104 through a wireless communication link 106 (wireless link 106). In this example, the computing device 102 is implemented as a smart phone. However, the computing device 102 may be implemented as any suitable computing or electronic device, such as a modem, cellular base station, broadband router, access point, cellular phone, gaming device, navigation device, media device, laptop computer, desktop computer, tablet computer, server, network-attached storage (NAS) device, smart appliance, vehicle-based communication system, and so forth.

The base station 104 communicates with the computing device 102 via the wireless link 106, which may be implemented as any suitable type of wireless link. Although depicted as a tower of a cellular network, the base station 104 may represent or be implemented as another device, such as a satellite, cable television head-end, terrestrial television broadcast tower, access point, peer-to-peer device, mesh network node, fiber optic line, and so forth. Therefore, the computing device 102 may communicate with the base station 104 or another device via a wired connection, a wireless connection, or a combination thereof.

The wireless link 106 can include a downlink of data or control information communicated from the base station 104 to the computing device 102 and an uplink of other data or control information communicated from the computing device 102 to the base station 104. The wireless link 106 may be implemented using any suitable communication protocol or standard, such as 3rd Generation Partnership Project Long-Term Evolution (3GPP LTE), IEEE 802.11, IEEE 802.16, Bluetooth™, and so forth.

The computing device 102 includes a processor 108 and a computer-readable storage medium 110 (CRM 110). The processor 108 may include any type of processor, such as an application processor or multi-core processor, that is configured to execute processor-executable code stored by the CRM 110. The CRM 110 may include any suitable type of data storage media, such as volatile memory (e.g., random access memory (RAM)), non-volatile memory (e.g., Flash memory), optical media, magnetic media (e.g., disk or tape), and so forth. In the context of this disclosure, the CRM 110 is implemented to store instructions 112, data 114, and other information of the computing device 102, and thus does not include transitory propagating signals or carrier waves.

The computing device 102 may also include input/output ports 116 (I/O ports 116) and a display 118. The I/O ports 116 enable data exchanges or interaction with other devices, networks, or users. The I/O ports 116 may include serial ports (e.g., universal serial bus (USB) ports), parallel ports, audio ports, infrared (IR) ports, and so forth. The display 118 presents graphics of the computing device 102, such as a user interface associated with an operating system, program, or application. Alternately or additionally, the display 118 may be implemented as a display port or virtual interface, through which graphical content of the computing device 102 is presented.

A wireless transceiver 120 of the computing device 102 provides connectivity to respective networks and other electronic devices connected therewith. Alternately or additionally, the computing device 102 may include a wired transceiver, such as an Ethernet or fiber optic interface for communicating over a local network, intranet, or the Internet. The wireless transceiver 120 may facilitate communication over any suitable type of wireless network, such as a wireless LAN (WLAN), peer-to-peer (P2P) network, mesh network, cellular network, wireless wide-area-network (WWAN), and/or wireless personal-area-network (WPAN). In the context of the example environment 100, the wireless transceiver 120 enables the computing device 102 to communicate with the base station 104 and networks connected therewith.

The wireless transceiver 120 includes at least one baseband modem 122 and at least one transceiver 124 (e.g., a radio-frequency transceiver) to process data and/or signals associated with communicating data of the computing device 102 over an antenna 132. The baseband modem 122 may be implemented as a system-on-chip (SoC) that provides a digital communication interface for data, voice, messaging, and other applications of the computing device 102. The baseband modem 122 may also include baseband circuitry to perform high-rate sampling processes that can include analog-to-digital conversion, digital-to-analog conversion, gain correction, skew correction, frequency translation, and so forth.

The transceiver 124 is coupled to the baseband modem 122 and includes circuitry and logic for transmitting in a transmission frequency band or receiving in a reception frequency band. The transceiver 124 can include band-pass filters, switches, amplifiers, and so forth for conditioning signals that are transmitted or received via the antenna 132. The transceiver 124 can further perform frequency conversion, which may include an upconverter and/or a downconverter that perform frequency conversion in a single conversion step, or through multiple conversion steps. The transceiver 124 may also include logic to perform in-phase/quadrature (I/Q) operations, such as synthesis, encoding, modulation, decoding, demodulation, and so forth. In some cases, components of the transceiver 124 are implemented as separate receiver and transmitter entities. Additionally or alternatively, the transceiver 124 can be realized using multiple or different sections to implement respective receiving and transmitting operations (e.g., separate transmit and receive chains).

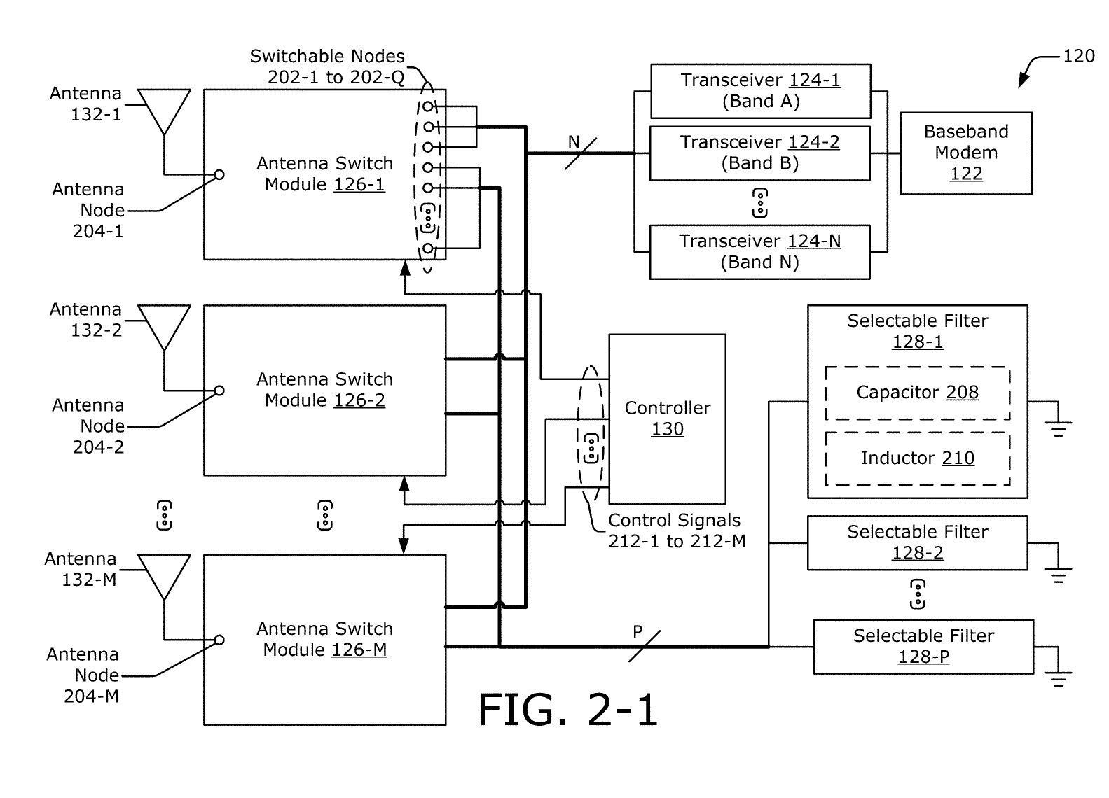

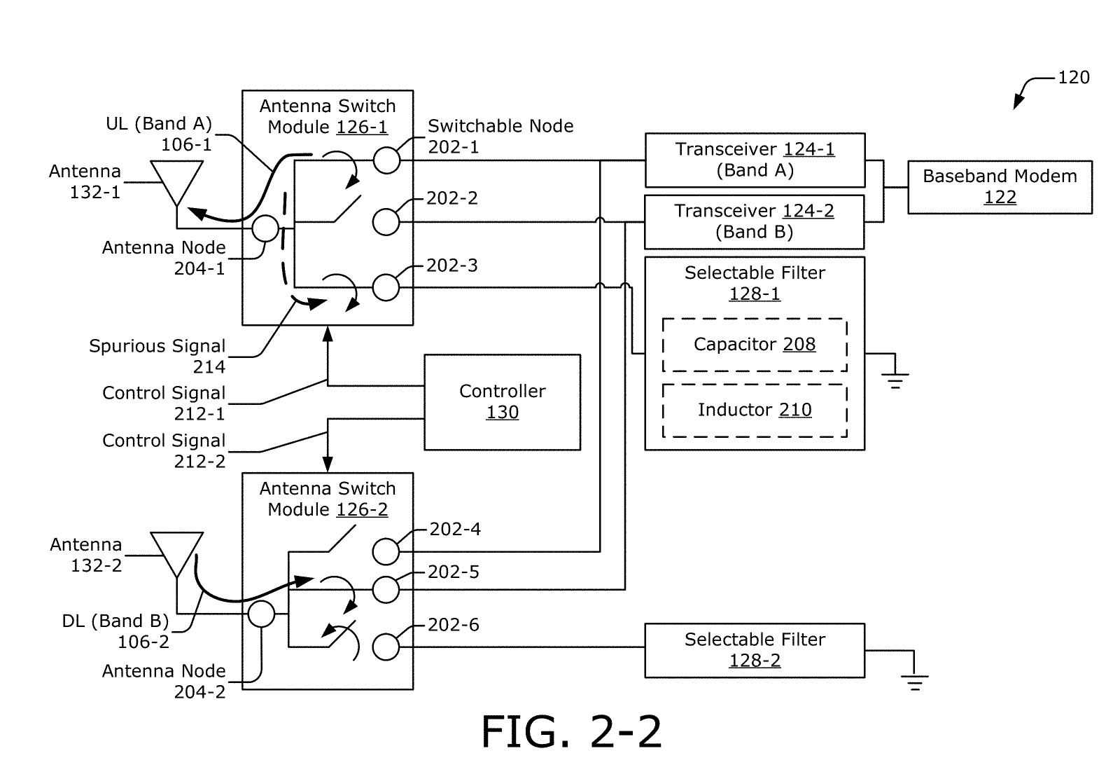

The wireless transceiver 120 also includes at least one antenna switch module 126, at least one selectable filter 128, and at least one controller 130. The antenna switch module 126, the selectable filter 128, and the controller 130, which are described with reference to FIGS. 2-1 and 2-2, can at least partially implement selectable filtering with switching.

FIG. 2-1 illustrates an example wireless transceiver 120. The wireless transceiver 120 includes a baseband modem 122, multiple transceivers 124-1 to 124-N, multiple antenna switch modules 126-1 to 126-M, multiple selectable filters 128-1 to 128-P, a controller 130, and multiple antennas 132-1 to 132-M. Here, the variables “N,” “M,” and “P” represent same or different positive integers.

In the depicted configuration, the baseband modem 122 is coupled to the multiple transceivers 124-1 to 124-N. Each of the multiple transceivers 124-1 to 124-N are configured for a different communication frequency band, such as band A for a first transceiver 124-1, band B for a second transceiver 124-2, and band N for an Nth transceiver 124-N.

Each antenna switch module 126 includes multiple switchable nodes 202-1 to 202-Q. Here, the variable “Q” represents a positive integer that can be a same or a different number for each antenna switch module 126. A portion of the multiple switchable nodes 202-1 to 202-Q are respectively coupled to the multiple transceivers 124-1 to 124-N and another portion of the multiple switchable nodes 202-1 to 202-Q are respectively coupled to the multiple selectable filters 128-1 to 128-P. For example, four of the multiple switchable nodes 202-1 to 202-Q are respectively coupled to the first transceiver 124-1, the second transceiver 124-2, a first selectable filter 128-1, and a second selectable filter 128-2.

Although all of the multiple transceivers 124-1 to 124-N and all of the selectable filters 128-1 to 128-P are shown to be coupled to each of the multiple antenna switch modules 126-1 to 126-M, each antenna switch module 126 can have a same or a different combination of the multiple transceivers 124-1 to 124-N and multiple selectable filters 128-1 to 128-P that are coupled to the multiple switchable nodes 202-1 to 202-Q. In some implementations, a portion of the multiple transceivers 124-1 to 124-N are coupled to a first antenna switch module 126-1 and another portion of the multiple transceivers 124-1 to 124-N are coupled to a second antenna switch module 126-2. Furthermore, some of the multiple antenna switch modules 126-1 to 126-M may be coupled to some of the multiple selectable filters 128-1 to 128-P and others of the multiple antenna switch modules 126-1 to 126-M may not be coupled to the multiple selectable filters 128-1 to 128-P.

Each antenna switch module 126 also includes a respective one of the multiple antenna nodes 204-1 to 204-M. The multiple antenna nodes 204-1 to 204-M couple the multiple antenna switch modules 126-1 to 126-M to respective ones of the multiple antennas 132-1 to 132-M. Although not depicted, each of the multiple antenna switch modules 126-1 to 126-M can be coupled to additional antennas 132 via one antenna node 204 or via multiple antenna nodes 204.

The antenna switch module 126 is configured to connect or disconnect the multiple switchable nodes 202-1 to 202-Q to or from the antenna node 204. To provide switching functionality, the antenna switch module 126 can be implemented using a variety of switches, such as micro-electromechanical (MEMS) switches, field-effect transistors, PIN diodes, and so forth. Through the switches, the antenna switch modules 126 is configured to pass a communication signal between the antenna node 204 and at least one of the multiple switchable nodes 202-1 to 202-Q.

The communication signals passed by the antenna switch module 126 can include multiple frequency components. In addition to including a communication component that is within the communication frequency band (e.g., the transmission frequency band or the reception frequency band, depending on the operation), the communication signal can also include at least one spurious component. The spurious component can result from non-linear components in the wireless transceiver 120 (e.g., power amplifiers, switches, or filters) or noise sources (e.g., external from or internal to the wireless transceiver 120). The spurious component has a spurious frequency that is unwanted and can decrease performance of the wireless transceiver 120. Example spurious frequencies include harmonic frequencies and/or intermodulation products that are associated with the communication frequency band. The spurious component can be referred to as a spurious signal, such as spurious signal 214. However, it is understood that the spurious signal 214 can be a component of the communication signal that is received by one of the multiple antenna switch modules 126-1 to 126-M. In some cases, at least one of the spurious frequencies falls within another communication frequency band that is associated with another one of the multiple transceivers 124-1 to 124-N. To provide sufficient cross-isolation between the communication frequency bands such that a spurious frequency does not interfere or reduce sensitivity, the antenna switch module 126 can enable at least one of the multiple selectable filters 128-1 to 128-P to attenuate the spurious frequency, as described in further detail below.

The multiple selectable filters 128-1 to 128-P are coupled between one of more of the multiple antenna switch modules 126-1 to 126-M and ground. Each of the multiple selectable filters 128-1 to 128-P is configured to provide attenuation for at least one of the multiple transceivers 124-1 to 124-N. The attenuation can be, for example, on the order of approximately five to fifteen decibels. Each of the multiple selectable filters 128-1 to 128-P are also configured to provide attenuation for at least one suppression frequency band.

The multiple selectable filters 128-1 to 128-P can be implemented using, for example, passive frequency-dependent components, such as a series-coupled capacitor 208 and inductor 210. A capacitance of the capacitor 208 and an inductance of the inductor 210 can be tuned for the suppression frequency band. The multiple selectable filters 128-1 to 128-P are effectively connected in a shunt configuration with any one or more of the multiple transceivers 124-1 to 124-N that are connected by the antenna switch modules 126. In this way, the multiple selectable filters 128-1 to 128-P can provide a low-impedance path to ground (e.g., an effective short circuit) for the suppression frequency band. Additionally, the multiple selectable filters 128-1 to 128-P are tuned so as to provide attenuation for the suppression frequency bands without appreciably increasing attenuation for the communication frequency bands that any connected ones of the multiple transceivers 124-1 to 124-N are configured to pass.

The multiple selectable filters 128-1 to 128-P can be tuned for similar or different suppression frequency bands. Additionally, the multiple antenna switch modules 126-1 to 126-M can be configured to connect more than one of the multiple selectable filters 128-1 to 128-P to attenuate more than one suppression frequency band during a communication operation.

The controller 130 includes control circuitry to generate multiple control signals 212-1 to 212-M. The controller 130 can route the multiple control signals 212-1 to 212-M to respective ones of the multiple antenna switch modules 126-1 to 126-M via a communication interface, such as a serial bus. In some aspects, the mobile industry processor interface (MIPI) radio-frequency front-end (RFFE) interface standard may be used for providing the multiple control signals 212-1 to 212-M. The multiple control signals 212-1 to 212-M can specify a switch configuration of respective ones of the multiple antenna switch modules 126-1 to 126-M.

FIG. 2-2 illustrates an example implementation of the wireless transceiver 120 of FIG. 2-1. The depicted implementation includes two transceivers 124-1 to 124-2 (e.g., “N”=2), two antenna switch modules 126-1 to 126-2 (e.g., “M”=2), two selectable filters 128-1 to 128-2 (e.g., “P”=2), and two antennas 132-1 to 132-2. A first transceiver 124-1 is configured to communicate on an uplink using transmission frequency band A, and a second transceiver 124-2 is configured to communicate on a downlink using reception frequency band B.

A first antenna switch module 126-1 includes a first switchable node 202-1 coupled to the first transceiver 124-1, a second switchable node 202-2 coupled to the second transceiver 124-2, and a third switchable node 202-3 coupled to a first selectable filter 128-1 (e.g., “Q”=3). Similarly, the second antenna switch module 126-2 includes a fourth switchable node 202-4 coupled to the first transceiver 124-1, a fifth switchable node 202-5 coupled to the second transceiver 124-2, and a sixth switchable node 202-6 coupled to a second selectable filter 128-2 (e.g., “Q”=3). The first antenna switch module 126-1 and the second antenna switch module 126-2 respectively include a first antenna node 204-1 coupled to a first antenna 132-1 and a second antenna node 204-2 coupled to a second antenna 132-2.

FIG. 2-2 illustrates a particular example state of the switches, whereby the first antenna switch module 126-1 connects the first switchable node 202-1 to the antenna node 204-1 to enable an uplink signal 106-1 to pass from the first transceiver 124-1 to the first antenna 132-1 and the second antenna switch module 126-2 connects the fifth switchable node 202-5 to the antenna node 204-2 to enable a downlink signal 106-2 to pass from the second antenna 132-2 to the second transceiver 124-2. In the depicted configuration, the controller 130 controls the switch configurations for the first antenna switch module 126-1 and the second antenna switch module 126-2 via a respective first control signal 212-1 and a respective second control signal 212-2.

In some situations, a spurious signal 214 is generated by the first transceiver 124-1 during the transmission operation. Although the spurious signal has a spurious frequency that is outside of the transmission frequency band used by the first transceiver 124-1, the spurious frequency can fall within the reception frequency band that is used by the second transceiver 124-2. Accordingly, the controller 130 can further configure the first antenna switch module 126-1 to connect the third switchable node 202-3 to the first antenna node 204-1 via the first control signal 212-1 so that the first selectable filter 128-1 attenuates the spurious signal 214.

Additionally, the controller 130 can determine that the second transceiver 124-2 is configured to receive the downlink signal 106-2. Consequently, the controller 130 can configure the second antenna switch module 126-2 to disconnect the sixth switchable node 202-6 from the second antenna node 204-2 to decrease an insertion loss for receiving the downlink signal 106-2. Furthermore, if the suppression frequency band that the second selectable filter 128-2 is tuned for lies within the reception frequency band, disconnecting the second selectable filter 128-2 ensures the selectable filter 128-2 does not attenuate the downlink signal 106-2.

As described above, the controller 130 can cause an antenna switch module 126 to enable a given selectable filter 128 for communication operations that benefit from the attenuation and disable the given selectable filter 128 for communication operations that do not benefit from the attenuation. In general, the controller 130 can cause the antenna switch module 126 to connect any one or more selectable filters 128 that have a suppression frequency band outside the transmission frequency band or the reception frequency band of a connected transceiver 124. This can be used to ensure that the given selectable filter 128 does not attenuate one of the communication signals being passed to or from the connected transceiver 124. The controller 130 can also reduce insertion loss for passing the communication signal by determining when the attenuation is not needed, such as when the connected transceiver 124 is receiving or when spurious frequencies generated by the connected transceiver 124 do not interfere with another transceiver 124.

The controller 130 can also cause the first antenna switch module 126-1 to connect the first selectable filter 128-1 for more than one of the multiple transceivers 124-1 to 124-N. For example, a third transceiver 124 (not shown) may be coupled to the first antenna switch module 126-1 via a fourth switchable nodes 202 (not shown). The third transceiver 124 can transmit another uplink signal 106 using another transmission frequency band while the second transceiver 124-2 receives the downlink signal 106-2. Accordingly, the controller 130 can determine whether to enable the first selectable filter 128-1 based on the other transmission frequency band. If the third transmitter generates a spurious signal with a frequency that falls within the reception frequency band of the second transceiver 124-2, the controller 130 can enable the first selectable filter 128-1 to provide the additional attenuation for the spurious frequency. Alternatively, if the frequency of the spurious signal does not fall within the reception frequency band B, the controller 130 can disable the first selectable filter 128-1 to decrease the insertion loss.

Although not explicitly described and illustrated, a noise signal that is received by the second antenna 132-2 from an external or internal noise source can also generate an additional spurious signal. While the noise signal can have a noise frequency outside of the reception frequency band of the second transceiver 124-2, the noise signal can interact with the non-linear components of the wireless transceiver 120 and cause the additional spurious signal to be generated. In other words, the additional spurious signal can be a harmonic or an intermodulation product of the noise signal. If the additional spurious signal has a frequency that falls within the reception frequency band, performance of the second transceiver 124-2 can decrease. Assuming the second selectable filter 128-2 is tuned to attenuate the noise frequency, the controller 130 can reduce the impact of the additional spurious signal by enabling the second antenna switch module 126-2 to connect the second selectable filter 128-2 while the second transceiver 124-2 is receiving. Thus, the interference caused by the additional spurious signal is reduced by attenuating the noise signal. In some implementations, the enabling of the second selectable filter 128-2 can be based on a determination by the controller 130 that the performance improvement gained by attenuating the noise signal is greater than an increase in insertion loss caused by enabling the second selectable filter 128-2.

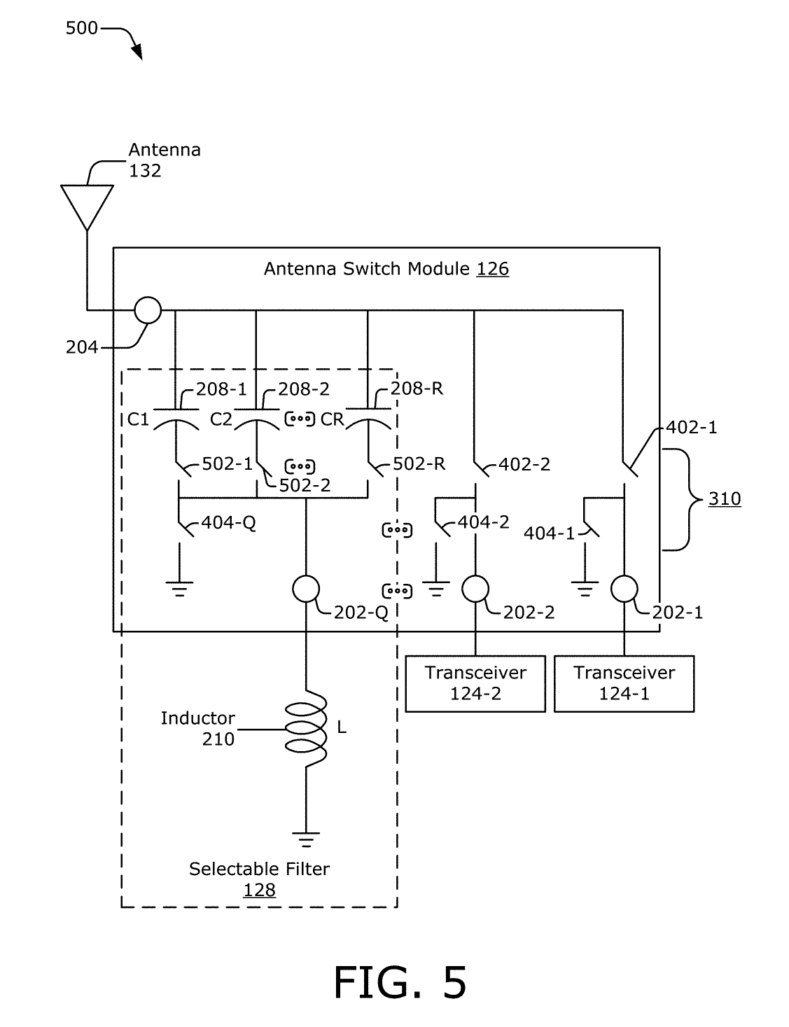

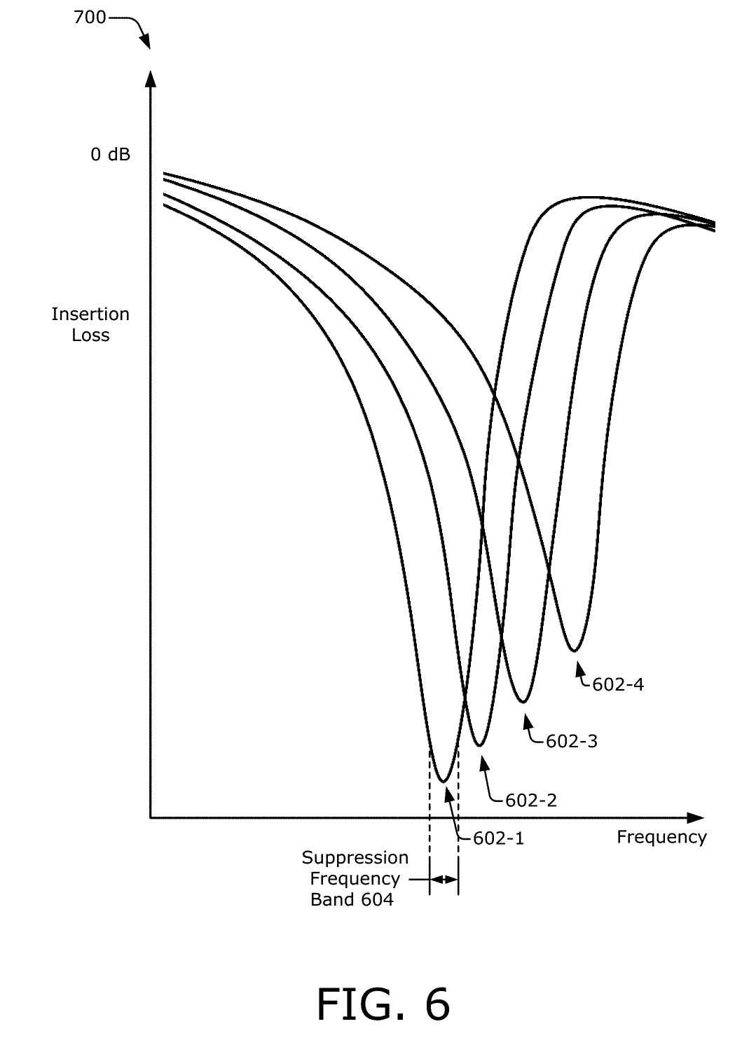

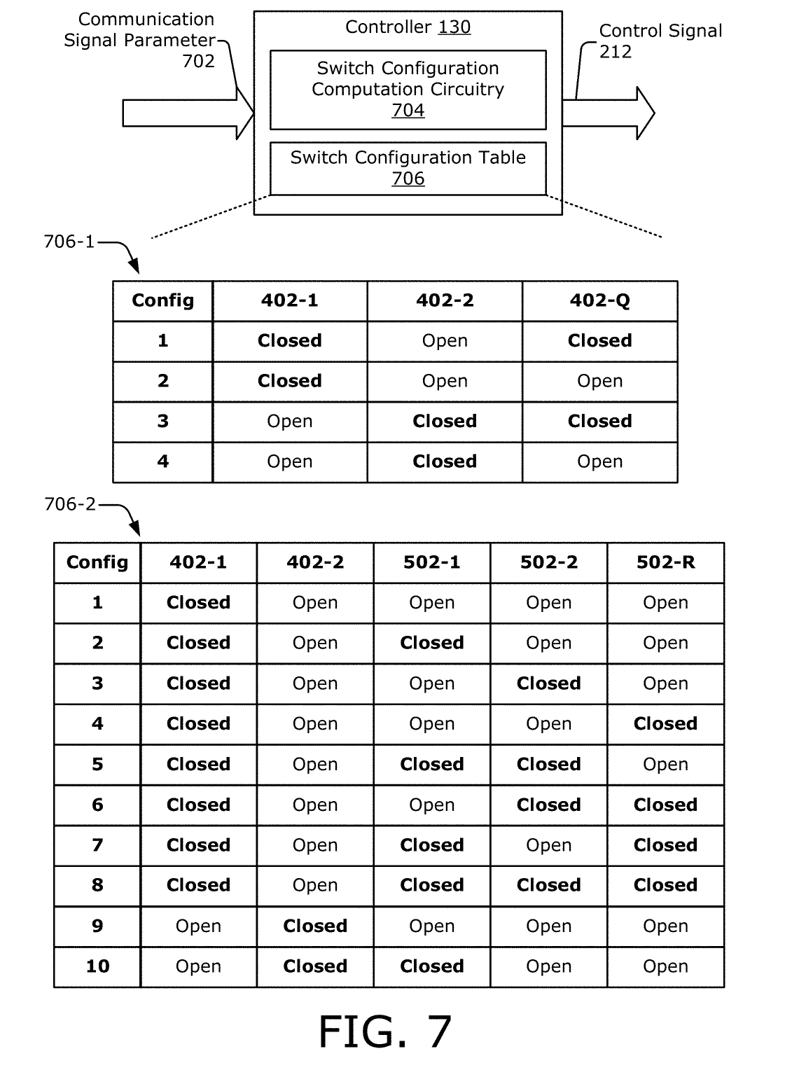

In some implementations, the controller 130 can cause the antenna switch module 126 to electronically tune the selectable filter 128 for different suppression frequency bands, as discussed in further detail in reference to FIGS. 5 and 6. Example techniques for controlling the antenna switch module 126 are also further described with reference to FIG. 7.

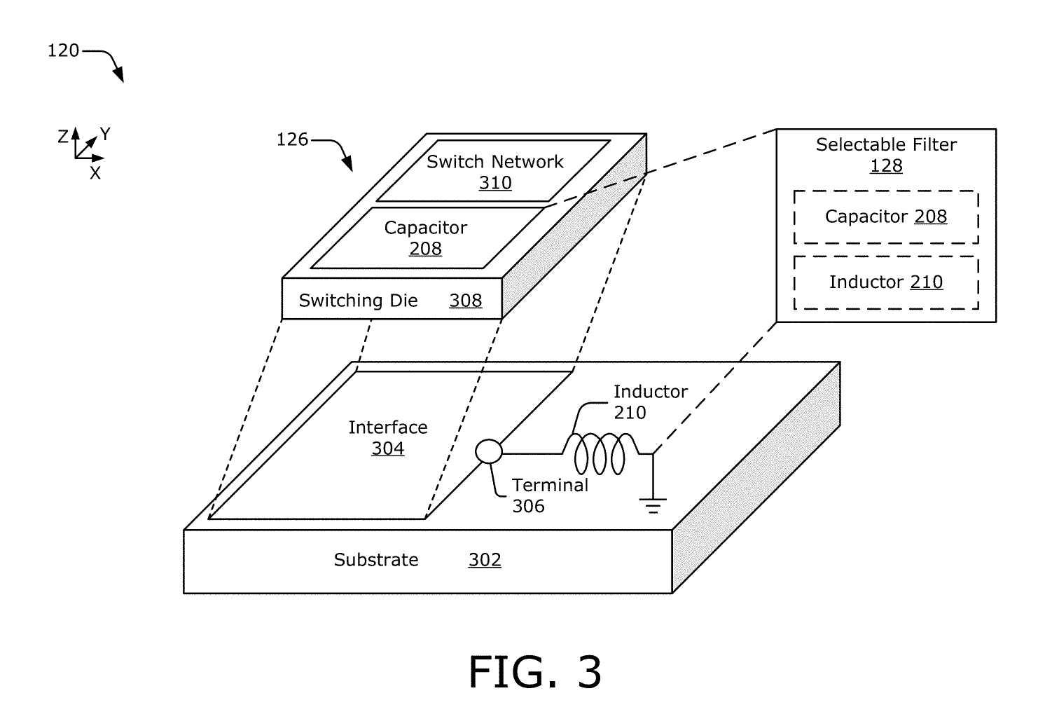

In some implementations, the capacitor 208 and the inductor 210 of the selectable filter 128 are solderable components (e.g., surface-mount devices (SMDs)) that are easily replaced during product development. This enables efficient tuning of the selectable filter 128 for the suppression frequency band, even after partial fabrication of the wireless transceiver 120. However, the capacitor 208 or the inductor 210 can alternatively be incorporated into a printed circuit board or embedded in a laminate. The selectable filter 128 can include any number of capacitors 208 or inductors 210, where some of the components are implemented together and others are distributed within a package, including within the antenna switch module 126. An example distributive configuration is illustrated in FIG. 3.

FIG. 3 illustrates an example distributive configuration for selectable filtering with switching. In the depicted configuration, the wireless transceiver 120 includes a substrate 302. The substrate 302 can include a laminate or multiple laminate layers that enable components of the selectable filter 128 to be embedded within the substrate 302. The substrate 302 also includes at least one interface 304 and at least one terminal 306. In the depicted configuration, the inductor 210 of the selectable filter 128 is coupled to the terminal 306 and supported by the substrate 302.

The interface 304, which is disposed on a surface of the substrate 302, is configured to accept and couple to the antenna switch module 126, which is implemented on a switching die 308. The interface 304 includes the terminal 306 and other electrical connections such as those for the multiple switchable nodes 202-1 to 202-Q and the antenna node 204. Thus, the interface 304 can include additional connections to couple the multiple switchable nodes 202-1 to 202-Q to the multiple transceivers 124-1 to 124-N and to couple the antenna node 204 to the antenna 132. Using the connections, the interface 304 can pass electrical signals between components that are on the substrate 302 and components that are on the switching die 308.

The antenna switch module 126 includes a switch network 310 having multiple switches configured to connect or disconnect the multiple switchable nodes 202-1 to 202-Q to or from the antenna node 204 based on the control signal 212 (of FIG. 2-1 and FIG. 2-2). In addition, for this example, the antenna switch module 126 is shown to include the capacitor 208 of the selectable filter 128. The capacitor 208 can be implemented on the switching die 308 using, for example, metal layers. By integrating the capacitor 208 in the antenna switch module 126, the use of surface-mount devices can be reduced, thereby reducing cost and saving space on the substrate 302.

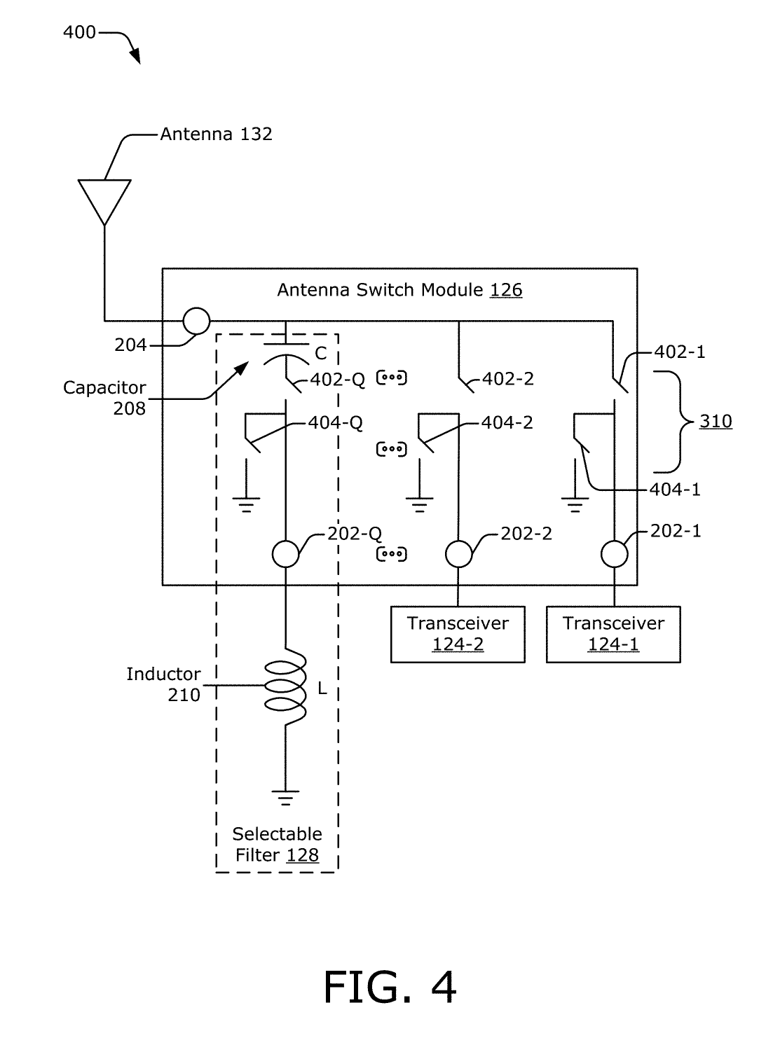

Although one inductor and one capacitor are explicitly depicted in FIG. 3 for implementing the selectable filter 128, more than one of either or both may be implemented. Example implementations of the antenna switch module 126 and the selectable filter 128 are described below in reference to FIGS. 4 and 5.

FIG. 4 illustrates an example of an antenna switch module 126 and selectable filter 128 for selectable filtering with switching, generally at 400. The antenna switch module 126 includes the switch network 310 having multiple switches 402-1 to 402-Q and multiple grounding switches 404-1 to 404-Q. The multiple switches 402-1 to 402-Q are respectively coupled between the multiple switchable nodes 202-1 to 202-Q and the antenna node 204. Each of the multiple switches 402-1 to 402-Q is configured to connect or disconnect a respective one of the multiple switchable nodes 202-1 to 202-Q to the antenna node 204. The multiple grounding switches 404-1 to 404-Q are respectively coupled between the multiple switchable nodes 202-1 to 202-Q and ground. The concepts and techniques for selectable filtering with switching can be applied to any number of multiple switches 402-1 to 402-Q, multiple grounding switches 404-1 to 404-Q, and multiple switchable nodes 202-1 to 202-Q.

Some of the multiple grounding switches 404-1 to 404-Q, such as a first grounding switch 404-1 and a second grounding switch 404-2, are configured to respectively ground the first switchable node 202-1 or the second switchable node 202-2 when the first switch 402-1 or the second switch 402-2 is open. In this way, the multiple grounding switches 404-1 to 404-Q provide isolation between each of the multiple switchable nodes 202-1 to 202-Q. Additionally, each one of the multiple grounding switches 404-1 to 404-Q provides protection from electrostatic discharge by providing a path to ground for an electrostatic current received at the respective one of the multiple switchable nodes 202-1 to 202-Q, even if the respective grounding switch 404 is open. In other words, the first grounding switch 404-1 can short the first switchable node 202-1 to ground responsive to occurrence of an electrostatic discharge event. In some implementations, even though a Qth grounding switch 404-Q that is associated with the selectable filter 128 may be configured to remain open, the Qth grounding switch 404-Q can also provide electrostatic discharge protection for the Qth switchable node 202-Q.

The antenna switch module 126 also includes the capacitor 208 of the selectable filter 128. In the depicted configuration, the capacitor 208 is coupled between the Qth switch 402-Q and the antenna node 204. The capacitor 208 can alternatively be coupled between the Qth switch 402-Q and the Qth switchable node 202-Q. In some implementations, the capacitor 208 is electronically-tunable, as described in further detail below with reference to FIGS. 5 and 6.

The selectable filter 128 also includes the inductor 210 having an inductance “L” that is coupled to the Qth switch 402-Q. The inductor 210 can be coupled to the third switch 402-Q via, for example, the interface 304 and the terminal 306, as shown in FIG. 3. As described above, the inductor 210 can be implemented as a surface-mount device. In this way, the selectable filter 128 can be readily tuned for another suppression frequency band in an alternative design by replacing the inductor 210 with another inductor having a different inductance.

FIG. 5 illustrates another example antenna switch module 126 and selectable filter 128 for selectable filtering with switching, generally at 500. In the depicted configuration, the antenna switch module 126 includes multiple capacitors 208-1 to 208-R that are respectively coupled in series with multiple switches 502-1 to 502-R, “R” representing a positive integer. From one perspective, the multiple switches 502-1 to 502-R collectively replace the Qth switch 402-Q of FIG. 4. The antenna switch module 126 can connect or disconnect the selectable filter 128 using the multiple switches 502-1 to 502-R and can further electronically adjust the capacitance of the selectable filter 128 by closing one or more of the multiple switches 502-1 to 502-R. By connecting different capacitors of the multiple capacitors 208-1 to 208-R, the selectable filter 128 can be dynamically tuned for different suppression frequency bands. Although three capacitors are explicitly depicted having respective capacitances “C1”, “C2”, and “CR”, any number of capacitors 208 may be implemented having any amount of capacitance. Furthermore, additional switches or configuration of switches may be used to combine the multiple capacitors 208-1 to 208-R in series, in parallel, or any combination thereof. In an example series configuration, multiple switched bypass paths enable one or more capacitors of the multiple capacitors 208-1 to 208-R to be bypassed in order to generate the required capacitance for the selectable filter 128.

FIG. 6 illustrates an example frequency response graph 600 for an electronically-tunable selectable filter 128. The frequency response graph 600 illustrates an attenuation provided by the selectable filter 128 across different frequencies. The frequency response graph 600 includes multiple responses 602-1 to 602-4. The multiple responses 602-1 to 602-4 represent different tuning configurations of the electronically-tunable selectable filter 128. Each of the responses 602-1 to 602-4 has a range of frequencies for which the attenuation is large. This range of frequencies corresponds to a suppression frequency band 604. By tuning the selectable filter 128, such as by adjusting a capacitance of the selectable filter 128 as described above with reference to FIG. 5, each of the responses 602-1 to 602-4 can be realized. A range of suppression frequency bands (e.g., from a first response 602-1 to a fourth response 602-4) for which the selectable filter 128 can be tuned depends on the implementation of the selectable filter 128. As an example, the range of suppression frequency bands can be on the order of five to ten gigahertz (GHz).

FIG. 7 illustrates example switch configuration tables for generating a control signal 212 for selectable filtering with switching. The controller 130 receives at least one communication signal parameter 702 providing information regarding a communication operation associated with the computing device 102. In some implementations, the communication signal parameter 702 can be provided to the controller 130 via the processor 108. The communication signal parameter 702 may identify one or more of the multiple transceivers 124-1 to 124-N for an uplink and a downlink. Additionally or alternatively, the communication signal parameter 702 can specify a transmission frequency band for the uplink or a reception frequency band for the downlink.

The controller 130 includes switch configuration computation circuitry 704 to determine a configuration of the antenna switch module 126. The controller 130 may also include (e.g., store or otherwise have access to) information regarding the components that are coupled to the switchable nodes 202 of the antenna switch module 126, such as the multiple selectable filters 128-1 to 128-P and the multiple transceivers 124-1 to 124-N. Alternatively, the component information can be provided via the communication signal parameter 702.

The controller 130 can also include at least one switch configuration table 706. The switch configuration table 706 includes different switch configurations of the antenna switch module 126. The same switch configuration table 706 can be used for the multiple antenna switch modules 126-1 to 126-M, or different switch configuration tables 706 can be used for different ones of the multiple antenna switch modules 126-1 to 126-M.

A first example switch configuration table 706-1 is shown with respect to the switches depicted in FIG. 4. The switch configuration table 706-1 includes various configurations of the multiple switches 402-1 to 402-Q in terms of whether a given switch is in an open state or a closed state. In the first configuration (the first row), the first switch 402-1 is closed to connect the first transceiver 124-1 to the antenna 132, the second switch 402-2 is open to disconnect the second transceiver 124-2 from the antenna 132, and the Qth switch 402-Q is closed to connect the selectable filter 128 to antenna node 204. The first configuration may be used, for example, while the first transceiver 124-1 is transmitting a communication signal on the uplink. The second configuration is similar to the first configuration, except that the Qth switch 402-Q is in an open state to disconnect the selectable filter 128 from the antenna 132. The second configuration may be used, for instance, while the first transceiver 124-1 is receiving another communication signal for the downlink.

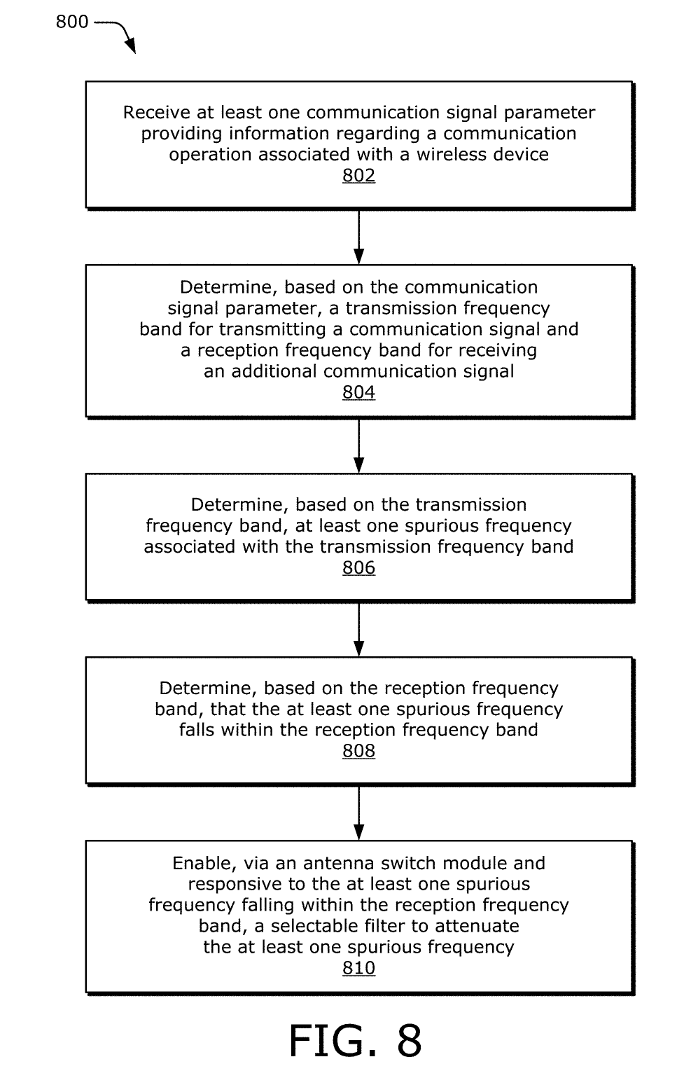

The third and fourth configurations are similar to the first and second configurations, except that the second transceiver 124-2 is connected to the antenna 132 while the first transceiver 124-1 is disconnected from the antenna 132. Similarly, the selectable filter 128 can be connected or disconnected based on whether the second transceiver 124-2 is transmitting or receiving. As discussed in further detail below with respect to FIG. 8, the controller 130 can determine the switch configuration responsive to, for example, which one of the multiple transceivers 124-1 or 124-N is being used for the communication operation and a transmission frequency band of the selected transceiver 124.

A second example switch configuration table 706-2 is shown with respect to the switches depicted in FIG. 5. The switch configuration table 706-2 includes various configurations of the multiple switches 402-1, 402-2, 502-1, 502-2, and 502-R. For illustration purposes, ten example configurations are depicted in FIG. 7. By including the switches 502-1 to 502-R that are used to electronically-tune the selectable filter 128 by selectively engaging one or more of the multiple capacitors 208-1 to 208-R, the controller 130 can determine a configuration to tune the selectable filter 128 for a desired suppression frequency band. In the first configuration, the selectable filter 128 is disconnected from the antenna 132 due to the switches 502-1 to 502-R being in an open state. In the second configuration, the switch 502-1 is closed, thereby enabling the selectable filter 128 and providing a total capacitance of “C1” for the selectable filter 128. In the third configuration, the switch 502-2 is closed, thereby enabling the selectable filter 128 and providing a total capacitance of “C2” for the selectable filter 128. In the fifth configuration, both the switch 501-1 and 502-2 are closed, thereby providing a total capacitance of “C1+C2” for the selectable filter 128. The different configurations two through eight can be used to attenuate different spurious frequencies that are associated with the first transceiver 124-1 or based on different transceivers 124 receiving while the first transceiver 124-1 is transmitting.

In general, the selectable filter 128 can be connected, disconnected, or tuned for different operations associated with a same transceiver 124 (e.g. transmitting or receiving) or for operations associated with other transceivers 124 (e.g. the other transceiver 124 receiving). The controller 130 can also include logic to enhance communication operations by balancing the providing of additional attenuation with the providing of less insertion loss.

Using the switch configuration table 706, the controller 130 can generate the control signal 212 to configure the antenna switch module 126. In some implementations, the controller 130 may write the determined configuration to a register that is used to generate the control signal 212. Although not shown, the switch configuration table 706 can also include configurations specifying an open or closed state of some of the multiple grounding switches 404-1 to 404-Q. An example flow diagram is illustrated in FIG. 8 for controlling the antenna switch module 126.

FIG. 8 is a flow diagram illustrating an example process 800 for controlling an antenna switch module for selectable filtering with switching. The process 800 is described in the form of a set of blocks 802-810 that specify operations that can be performed. However, operations are not necessarily limited to the order shown in FIG. 8 or described herein, for the operations may be implemented in alternative orders or in fully or partially overlapping manners. Operations represented by the illustrated blocks of the process 800 may be performed by a controller 130 (e.g., of FIGS. 1, 2, and 7).

At block 802, at least one communication signal parameter is received. For example, the communication signal parameter 702 can be received by the controller 130. The communication signal parameter 702 provides information regarding a communication operation associated with a wireless device, such as the computing device 102. The communication signal parameter 702 may identify one or more of the multiple transceivers 124-1 to 124-N for transmitting a communication signal and receiving another communication signal. Additionally or alternatively, the communication signal parameter 702 can specify a transmission frequency band or a reception frequency band.

At block 804, a transmission frequency band for transmitting a communication signal and a reception frequency band for receiving a communication signal are determined based on the communication signal parameter. For example, the controller 130 can use a look-up table to associate one of the multiple transceivers 124-1 to 124-N with the transmission frequency band and another one of the multiple transceivers 124-1 to 124-N with the reception frequency band. Considering FIG. 2-2, the controller 130 may determine that the first transceiver 124-1 is associated with a transmission frequency band that includes frequencies between 699 and 716 MHz and that the second transceiver 124-2 is associated with a reception frequency band that includes frequencies between 2110 and 2155 MHz.

At block 806, at least one spurious frequency that is associated with the transmission frequency band is determined based on the transmission frequency band. The spurious frequency can include a harmonic frequency, an intermodulation product, or both. For example, the controller 130 can use the switch configuration computation circuitry 704 to compute a first harmonic, a second harmonic, a third harmonic, first-order intermodulation products, second-order intermodulation products, third-order intermodulation products, and so forth. In some cases, the spurious frequency can refer to a single frequency or a range of spurious frequencies. Continuing with the above example, the controller 130 may determine that the first harmonic includes frequencies between 1398 and 1432 MHz, the second harmonic includes frequencies between 2097 and 2148 MHz, and the third harmonic includes frequencies between 2796 and 2864 MHz.

At block 808, the at least one spurious frequency is determined to fall within the reception frequency band. For example, the second harmonic having frequencies between 2097 and 2148 MHz can be determined to fall within the reception frequency band having frequencies between 2110 and 2155 MHz. Thus, a spurious frequency, such as a harmonic frequency or an intermodulation product, that at least falls within a portion of a reception frequency band can be identified.

At block 810, a selectable filter is enabled, via an antenna switch module, to attenuate the at least one spurious frequency responsive to the spurious frequency falling within the reception frequency band. In some implementations, the suppression frequency band 604 of the selectable filter 128 can be tuned for the spurious frequency, such as by determining the switch configuration in 706-2 that provides the desired capacitance for the selectable filter 128. Responsive to the spurious frequency being outside the reception frequency band, the controller 130 can determine another switch configuration in 706-2 that disables the selectable filter 128. In this way, the insertion loss can be decreased when the selectable filter 128 is not helpful. The process can continue to repeat at 802 based on changing transmit and receive operations. In general, the controller 130 can enable and configure the selectable filter 128 for any spurious signal that may be present during an operation of one of the multiple transceivers 124-1 to 124-N and that may decrease sensitivity or cause interference during an operation of another one of the multiple transceivers 124-1 to 124-N.

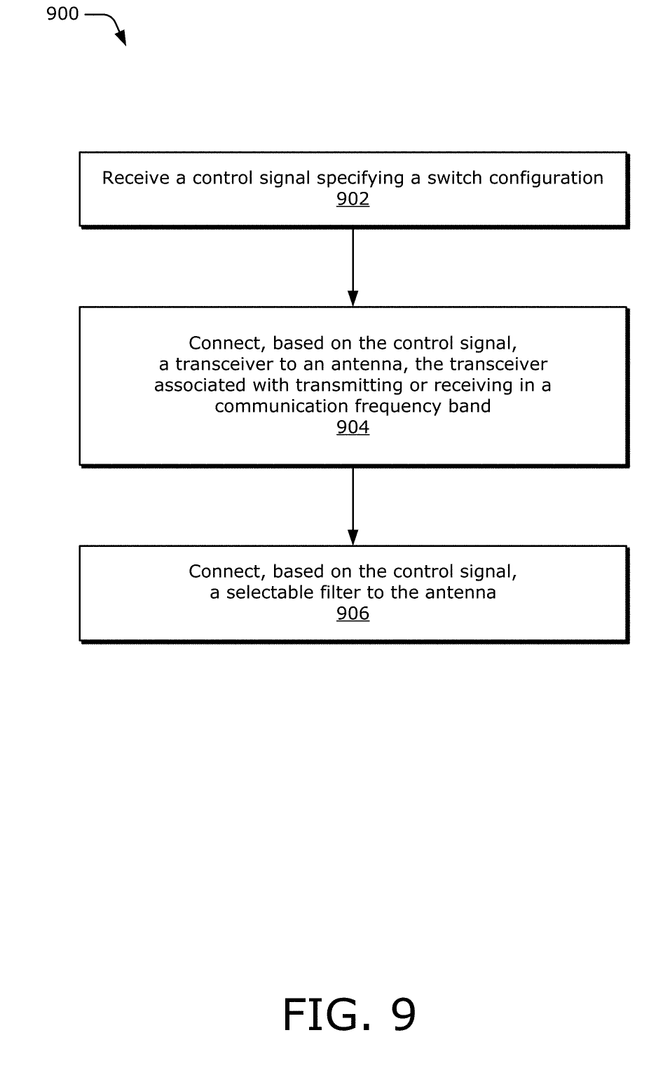

FIG. 9 is a flow diagram illustrating an example process 900 for selectable filtering with switching. The process 900 is described in the form of a set of blocks 902-906 that specify operations that can be performed. However, operations are not necessarily limited to the order shown in FIG. 9 or described herein, for the operations may be implemented in alternative orders or in fully or partially overlapping manners. Operations represented by the illustrated blocks of the process 900 may be performed by an antenna switch module 126 (e.g., of FIGS. 1-5).

At block 902, a control signal specifying a switch configuration is received. For example, the control signal 212 can be received by the antenna switch module 126 via the controller 130 over a serial bus.

At block 904, a transceiver is connected to an antenna based on the control signal. For example, one of the multiple transceivers 124-1 to 124-N can be connected to one of the multiple antennas 132-1 to 132-M via one of the multiple antenna switch modules 126-1 to 126-M. The transceiver 124 is associated with transmitting or receiving signals in a communication frequency band. In some cases, the transceiver may not be able to provide sufficient attenuation for a suppression frequency band.

At block 906, a selectable filter is connected to the antenna based on the control signal. In some implementations, the antenna switch module 126 includes one capacitor 208 or multiple capacitors 208-1 to 208-R and the connecting of the selectable filter 128 includes connecting the one capacitor 208 or the multiple capacitors 208-1 to 208-R to provide capacitance for the selectable filter 128. The selectable filter 128 provides attenuation for the suppression frequency band by providing a low-impedance path to ground for the suppression frequency band.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Further, items represented in the accompanying figures and terms discussed herein may be indicative of one or more items or terms, and thus reference may be made interchangeably to single or plural forms of the items and terms in this written description. Finally, although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. An apparatus comprising:
a substrate having a surface;
an antenna switch module mounted to the surface of the substrate, the antenna switch module including:
an antenna node configured to couple to an antenna;
multiple switchable nodes including a first switchable node;
multiple switches configured to connect or disconnect the multiple switchable nodes to or from the antenna node, the multiple switches including a first switch coupled between the antenna node and the first switchable node; and
a capacitor coupled in series with the first switch between the antenna node and the first switchable node, the capacitor configured to provide a capacitance for a selectable filter; and
an inductor supported by the substrate and coupled between the first switchable node and a ground, the inductor configured to provide an inductance for the selectable filter.

2. The apparatus of claim 1, further comprising a transceiver coupled to a second switchable node of the multiple switchable nodes, the transceiver configured to transmit in a transmission frequency band, wherein:
the selectable filter is configured to attenuate, via the capacitor and the inductor, signals in a suppression frequency band.

3. The apparatus of claim 2, wherein the antenna switch module is configured to:
connect the transceiver to the antenna node via a second switch of the multiple switches; and
connect the selectable filter to the antenna node via the first switch while the transceiver is transmitting.

4. The apparatus of claim 3, wherein the suppression frequency band includes a harmonic frequency of the transmission frequency band.

5. The apparatus of claim 4, further comprising another transceiver coupled to another antenna switch module, the other transceiver configured to receive in a reception frequency band, wherein:
the suppression frequency band lies within the reception frequency band.

6. The apparatus of claim 3, wherein:
the transceiver is further configured to receive in a reception frequency band; and
the antenna switch module is further configured to disconnect the selectable filter from the antenna node via the first switch while the transceiver is receiving.

7. The apparatus of claim 6, wherein the disconnection of the selectable filter from the antenna node is effective to reduce an insertion loss for the transceiver.

8. The apparatus of claim 3, further comprising:
another transceiver coupled to a third switchable node of the multiple switchable nodes, the other transceiver configured to transmit in another transmission frequency band, wherein:
the antenna switch module is further configured to:
disconnect the transceiver from the antenna node via the second switch;
connect the other transceiver to the antenna node via a third switch of the multiple switches; and
connect the selectable filter to the antenna node via the first switch while the other transceiver is transmitting.

9. The apparatus of claim 1, wherein:
the first switch comprises a set of switches;
the capacitor comprises a set of capacitors, the set of capacitors and the set of switches coupled between the antenna node and the first switchable node, individual capacitors of the set of capacitors coupled in parallel with each other; and
the antenna switch module is configured to:
connect one or more capacitors of the set of capacitors to provide a selectable capacitance for the selectable filter; and
enable, based on the selectable capacitance, the selectable filter to attenuate signals in a selectable suppression frequency band.

10. The apparatus of claim 9, further comprising another transceiver coupled to another antenna switch module, the other transceiver configured to receive in a reception frequency band, wherein:
the connection of the one or more capacitors is based on the reception frequency band.

11. The apparatus of claim 1, wherein the antenna switch module further comprises a grounding switch coupled to the first switchable node.

12. The apparatus of claim 1, wherein the inductor is a surface-mount device.

13. The apparatus of claim 1, further comprising control circuitry configured to generate a control signal based on a communication operation, wherein:
the antenna switch module is configured to connect or disconnect the first switchable node to or from the antenna node based on the control signal.

14. An apparatus comprising:
a substrate having a surface;
an antenna switch module mounted to the surface of the substrate, the antenna switch module including:
an antenna node configured to couple to an antenna;
multiple switchable nodes including a first switchable node;
multiple switches configured to connect or disconnect the multiple switchable nodes to or from the antenna node, the multiple switches including a first switch coupled between the antenna node and the first switchable node; and
a capacitor coupled in series with the first switch between the antenna node and the first switchable node; and
filter means for filtering signals present at the antenna node using the capacitor and the first switch.

15. The apparatus of claim 14, further comprising a transceiver coupled to a second switchable node of the multiple switchable nodes, the transceiver configured to transmit in a transmission frequency band, wherein:
the multiple switches includes a second switch coupled between the antenna node and the second switchable node;
the antenna switch module is configured to selectively connect the transceiver to the antenna node via the second switch;
the filter means is configured to selectively attenuate signals in a suppression frequency band by closing the first switch to engage the capacitor; and
the apparatus further comprises control means for controlling the antenna switch module to connect the filter means to the antenna node based on the transceiver being connected to the antenna node.

16. The apparatus of claim 15, wherein:
the transceiver is further configured to receive in a reception frequency band; and
the control means comprises means for controlling the antenna switch module to disconnect the filter means from the antenna node based on the transceiver receiving.

17. The apparatus of claim 15, further comprising:
another transceiver coupled to a third switchable node of the multiple switchable nodes, the other transceiver configured to transmit in another transmission frequency band, wherein:
the multiple switches include a third switch coupled between the antenna node and the third switchable node;
the antenna switch module is further configured to:
disconnect the transceiver from the antenna node via the second switch; and
connect the other transceiver to the antenna node via the third switch; and
the control means comprises means for controlling the antenna switch module to connect the filter means to the antenna node via the first switch based on the other transceiver being connected to the antenna node.

18. The apparatus of claim 14, wherein:
the capacitor comprises a set of capacitors; and
the filter means comprises means for adjusting a total capacitance of the set of capacitors.

19. A method for selectable filtering with switching, the method comprising:
receiving at least one communication signal parameter providing information regarding a communication operation associated with a wireless device;
determining, based on the communication signal parameter, a transmission frequency band for transmitting a communication signal and a reception frequency band for receiving an additional communication signal;
determining, based on the transmission frequency band, at least one spurious frequency associated with the transmission frequency band;
determining, based on the reception frequency band, that the at least one spurious frequency falls within the reception frequency band; and
enabling, via an antenna switch module and responsive to the at least one spurious frequency falling within the reception frequency band, a selectable filter to attenuate the at least one spurious frequency.

20. The method of claim 19, wherein the enabling comprises adjusting, via the antenna switch module, a capacitance of the selectable filter.

21. The method of claim 19, wherein the at least one spurious frequency includes at least one intermodulation product associated with the transmission frequency band.

22. The method of claim 19, wherein:
the at least one spurious frequency includes multiple spurious frequencies that are associated with the transmission frequency band; and
the multiple spurious frequencies include a harmonic frequency and an intermodulation product associated with the transmission frequency band.

23. The method of claim 19, wherein:
the enabling comprises generating a control signal indicative of a switch configuration of the antenna switch module; and
the enabling is responsive to the communication signal being transmitted while the additional communication signal is being received.

24. The method of claim 19, further comprising disabling, based on the at least one spurious frequency being outside the reception frequency band, the selectable filter.

25. The method of claim 19, further comprising:
receiving another communication signal parameter providing information regarding another communication operation associated with the wireless device;
determining, based on the other communication signal parameter, another transmission frequency band for transmitting another communication signal;
determining, based on the other transmission frequency band, at least one other spurious frequency associated with the other transmission frequency band;
determining, based on the reception frequency band, that the at least one other spurious frequency falls within the reception frequency band; and
enabling, via the antenna switch module and responsive to the at least one other spurious frequency falling within the reception frequency band, the selectable filter to attenuate the at least one other spurious frequency.

26. An apparatus comprising:
a first antenna;
a first transceiver;
a first antenna switch module including:
a first antenna node coupled to the first antenna;
a first switchable node coupled to the first transceiver; and
a first switch configured to connect or disconnect the first switchable node to or from the first antenna node;
a second antenna;
a second transceiver;
a second antenna switch module including:
a second antenna node coupled to the second antenna;
multiple switchable nodes including a second switchable node and a third switchable node, the second switchable node coupled to the second transceiver;
multiple switches configured to connect or disconnect the multiple switchable nodes to or from the second antenna node, the multiple switches including a second switch and a third switch, the second switch coupled between the second antenna node and the second switchable node, the third switch coupled between the second antenna node and the third switchable node; and
a capacitor coupled in series with the third switch between the second antenna node and the third switchable node, the capacitor configured to provide at least a portion of a capacitance for a selectable filter; and
an inductor coupled between the third switchable node and a ground, the inductor configured to provide an inductance for the selectable filter.

27. The apparatus of claim 26, wherein:
the first transceiver is configured to receive in a reception frequency band;
the second transceiver is configured to transmit in a transmission frequency band;
the transmission frequency band is associated with a spurious frequency that falls within the reception frequency band;
the selectable filter is configured to attenuate, via the capacitor and the inductor, signals in a suppression frequency band, the suppression frequency band including the spurious frequency;
the first antenna switch module is configured to connect the first transceiver to the first antenna node via the first switch; and
the second antenna switch module is configured to:
connect the second transceiver to the second antenna node via the second switch; and
connect the selectable filter to the second antenna node via the third switch while the first transceiver is receiving.

28. The apparatus of claim 27, further comprising a third transceiver configured to receive in another reception frequency band, wherein:
the other reception frequency band does not include the spurious frequency;
the first antenna switch module includes:
a fourth switchable node coupled to the third transceiver; and
a fourth switch configured to connect or disconnect the fourth switchable node to or from the first antenna node;
the first antenna switch module is further configured to:
disconnect the first transceiver from the first antenna node via the first switch; and
connect the third transceiver to the first antenna node via the fourth switch; and
the second antenna switch module is further configured to disconnect the selectable filter from the antenna node via the third switch while the third transceiver is receiving.

29. The apparatus of claim 27, further comprising a third transceiver configured to transmit in another transmission frequency band, wherein:
the other transmission frequency band is associated with another spurious frequency that falls within the reception frequency band;
the second antenna switch module includes:
a fourth switchable node coupled to the third transceiver; and
a fourth switch configured to connect or disconnect the fourth switchable node to or from the second antenna node; and
the second antenna switch module is further configured to:
disconnect the second transceiver from the second antenna node via the first switch;
connect the third transceiver to the second antenna node via the fourth switch; and
connect the selectable filter to the second antenna node via the third switch while the third transceiver is transmitting.

30. The apparatus of claim 26, further comprising another selectable filter configured to attenuate signals in a suppression frequency band, wherein:
the first transceiver is configured to receive in a reception frequency band;
the suppression frequency band does not fall within the reception frequency band;
the first antenna switch module further includes:
a fourth switchable node coupled to the other selectable filter; and
a fourth switch configured to connect or disconnect the fourth switchable node to or from the antenna node; and
the first antenna switch module is configured to connect the other selectable filter to the first antenna node via the fourth switch while the first transceiver is receiving.
